(19) United States
(12) Patent Application Publication
(10) Pub. No.: US 2016/0178041 A1
(43) Pub. Date: Jun. 23, 2016

(54) DRIVE ASSEMBLY FOR MACHINES

(71) Applicant: Caterpillar Inc., Peoria, IL (US)

(72) Inventor: Brandon L. Hagman, Decatur, IL (US)

(73) Assignee: Caterpillar Inc., Peoria, IL (US)

(21) Appl. No.: 15/058,172

(22) Filed: Mar. 2, 2016

(51) Int. Cl. F16H 37/08

(52) U.S. Cl. CPC F16H 37/082

(57) ABSTRACT

A drive assembly for motor graders is provided, which includes a differential gear arrangement and at least one final drive arrangement. The differential gear arrangement includes a differential housing and at least one differential output shaft. The final drive arrangement is driven by differential housing and the differential output shaft. The final drive arrangement includes a primary planetary gear assembly, a secondary planetary gear assembly, and a clutch. The primary planetary gear assembly includes a first sun gear powered by output shaft, two first planetary gears, a first ring gear positioned stationary, and a first planetary carrier fixed to a wheel drive mechanism. The secondary planetary gear assembly includes second sun gear powered by the differential housing, second planetary gear, second ring gear, and second planetary carrier fixed to the first planetary carrier. The clutch partially engages and disengages with the second ring gear, to correspondingly partially restrict and release the second ring gear.

### TECHNICAL FIELD

The present disclosure relates generally to drive assemblies for machines. More specifically, the present disclosure relates to torque vectoring in a drive assembly of a machine, with use of a primary planetary gear assembly applied in conjunction with a secondary planetary gear assembly of a final drive arrangement.

### BACKGROUND

Machines, such as motor graders, are commonly known to employ a number of rear wheels, with one or more rear wheels installed on each side of the machine. Such machines employ a drive assembly that drive the rear wheels installed on each side of the machine, to facilitate machine travel and maneuverability. The drive assembly generally include a differential gear arrangement that drives the rear wheels on each side, by way of individual final drive arrangements.

Furthermore, during several operational instances, ground engaging tools (GETs) associated with the machine are required to operate at an angle relative to the direction of the machine's motion. For example, a blade of the motor grader is required to be positioned at an angle relative to the direction of the motor grader's operation. As a result, the GETs are bound to sustain a side-load owing to its angular deployment and therefore an unwarranted turning moment is imparted to the machine. In order to counter this turning moment, a steering mechanism is conventionally operated, to steer the frontal wheels at an angle relative to the travel direction. This imparts a counter turning moment on the machine and facilitates machine maneuver in a straight direction, along the travel direction. However, such a manipulation requires a continuous operator intervention and imparts stresses on a frame of the machine. This results in wastage of energy and power, and is generally commensurately beset with frequent visits for service and repairs owing to the associated consequential issues of wear and tear. In addition, wastage of energy corresponds to reduction in overall efficiency of the machine.

U.S. Pat. No. 7,601,089 discloses a drive mechanism of a drive axle assembly for use in a motor vehicle. The drive mechanism includes a differential, a speed-changing unit, a first mode clutch, a second mode clutch, and a brake unit. The brake unit, in conjunction with the speed-changing unit and the first clutch, is operable to decrease speed of the first axle shaft and correspondingly speed of the first pair of wheel. Although, the braking unit is capable of decreasing speed of the first pair of wheels, the braking unit consumes relatively more power and is inefficient.

Accordingly, the system and method of the present disclosure solves one or more problems set forth above and other problems in the art.

### SUMMARY OF THE INVENTION

Various aspects of the present disclosure describe a drive assembly for a machine. The drive assembly includes a differential gear arrangement and at least one final drive arrangement. The differential gear arrangement includes a differential housing and at least one differential output shaft. The final drive arrangement is configured to be driven by the differential housing and the at least one output shaft. The tandem drive includes a primary planetary gear assembly, a secondary planetary gear assembly, and a clutch. The primary planetary gear assembly includes a first sun gear, at least one first planetary gear, a first ring gear, and a first planetary carrier. One of the at least one first planetary gear and the first ring gear is kept stationary. The first sun gear is powered by the differential output shaft of the differential gear arrangement. The first planetary carrier is fixedly attached to a wheel drive mechanism. The secondary planetary gear assembly includes a second sun gear, at least one second planetary gear, a second ring gear, and a second planetary carrier. The second sun gear is connected to and powered by the differential housing of the differential gear arrangement. The second planetary carrier is fixedly connected to the first planetary carrier. The clutch is adapted to at least partially engage and disengage with the second ring gear, to correspondingly at least partially restrict and release the second ring gear of the second planetary gear assembly. Therefore, torque flows to the wheel drive mechanism via each of the first planetary carrier of the primary planetary gear assembly and the second planetary carrier of the second planetary gear assembly, when the second ring gear is restricted. Additionally, torque flows via the first planetary carrier of the primary planetary gear assembly, when the second ring gear is released.

### BRIEF DESCRIPTION OF THE DRAWINGS

FIG. 1 is a perspective view of an exemplary machine, in accordance with the concepts of the present disclosure;

FIG. 2 is a perspective view of a drive assembly of the machine of FIG. 1, in accordance with the concepts of the present disclosure;

FIG. 3 is a top sectional view of the right hand side (RHS) portion of the drive assembly showing a differential gear arrangement and one of the two final drive arrangement of the drive assembly of FIG. 2, in accordance with the concepts of the present disclosure; and

FIG. 4 is a schematic of the right hand side (RHS) portion of the drive assembly of FIG. 2, which illustrates arrangement between the differential gear arrangement and one of the two final drive arrangement, to drive a singular rear wheel, in accordance with the concepts of the present disclosure.

### DETAILED DESCRIPTION

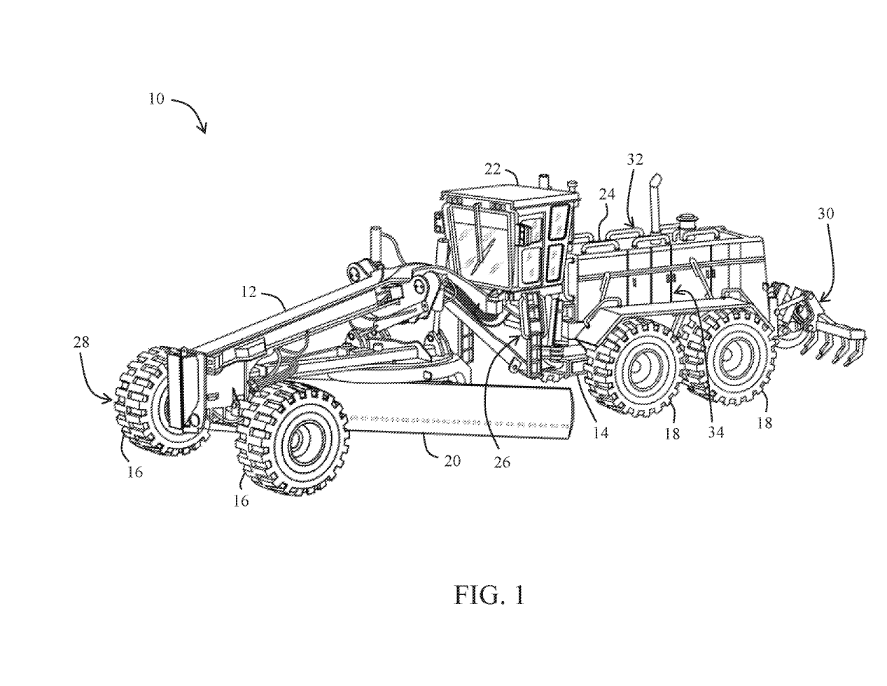

Referring to FIG. 1, there is shown a machine 10 as a motor grader 10, which facilitates levelling of a ground surface, during a grading operation. Although, the machine 10 is shown as the motor grader 10 in the present disclosure, various other types of the machine 10 may also be contemplated. Examples of the machine 10 may include, such as but not limited to, a mining truck, a wheel loader, a shovel, and a backhoe loader. For ease in reference and understanding, the machine 10 will be referred to as the motor grader 10, interchangeably hereinafter. The motor grader 10 includes a frontal frame 12, a rear frame assembly 14, two frontal wheels 16, four rear wheels 18 (two of which are shown in FIG. 1), a blade 20, an operator cabin 22, an engine compartment 24, and a drive assembly 26.

The frontal frame 12 is an elongated structure positioned proximal to a frontal end 28 of the motor grader 10. The frontal frame 12 is steerable, relative to the rear frame assembly 14 of the motor grader 10. The frontal frame 12 is adapted to rotatably support the blade 20 of the motor grader 10 that levels the ground surface, while performing the grading operation. The blade 20 is generally rotatably positioned at an angle, relative to a direction of motion of the motor grader 10. Additionally, the frontal frame 12 rotatably supports the frontal wheels 16 of the motor grader 10.

The rear frame assembly 14 is positioned proximal to a rear end 30 of the motor grader 10 and is rotatably attached to the frontal frame 12. The rear frame assembly 14 is adapted to support the operator cabin 22 and the engine compartment 24 of the motor grader 10. An operator is generally positioned in the operator cabin 22, to access a number of control circuitries (not shown) associated with the motor grader 10. Additionally, the rear frame assembly 14 supports the rear wheels 18 that facilitate machine maneuvering, during the grading operation.

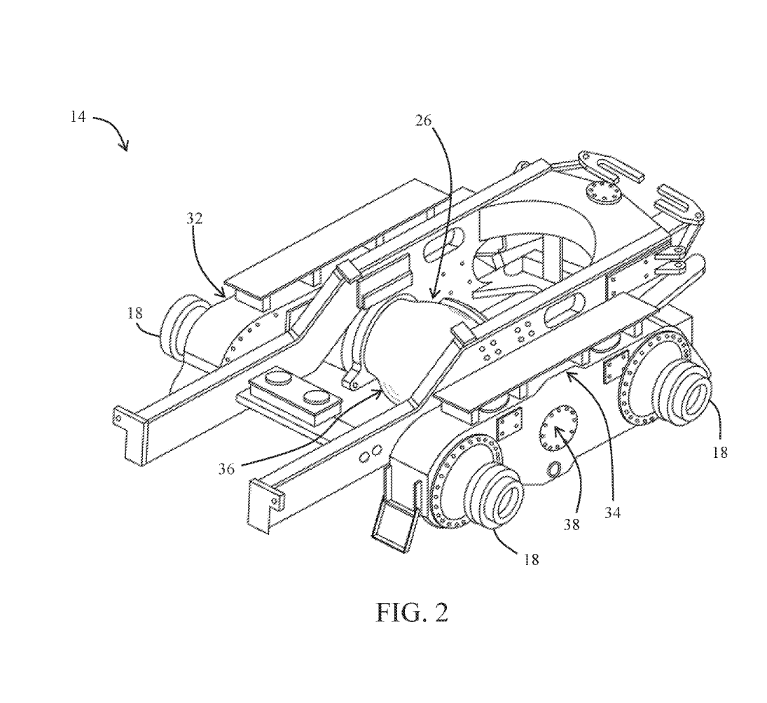

In the current embodiment, the motor grader 10 includes two frontal wheels 16 and four rear wheels 18. One frontal wheel 16 is rotatably installed on a first side 32 of the motor grader 10 and other frontal wheel 16 is rotatably installed on a second side 34 of the motor grader 10. Similarly, two rear wheels 18 are rotatably installed on the first side 32 of the motor grader 10 and other two rear wheels 18 are rotatably installed on the second side 34 of the motor grader 10. Further, the rear wheels 18 are connected to and powered by the drive assembly 26 (FIG. 2), to maneuver the motor grader 10 forward.

Referring to FIG. 2, the drive assembly 26 is operably connected between the engine (not shown) and the rear wheels 18. The drive assembly 26 is adapted to transmit engine torque from the engine (not shown) to the rear wheels 18 on each of the first side 32 and the second side 34 of the motor grader 10. Moreover, the drive assembly 26 is adapted to facilitate selective engine torque transmission from the engine (not shown) to the rear wheels 18 installed on each of the first side 32 and the second side 34 of the motor grader 10. This phenomenon of selective torque transmission to the rear wheels 18 installed on each of the first side 32 and the second side 34 of the motor grader 10, is termed as “torque vectoring”.

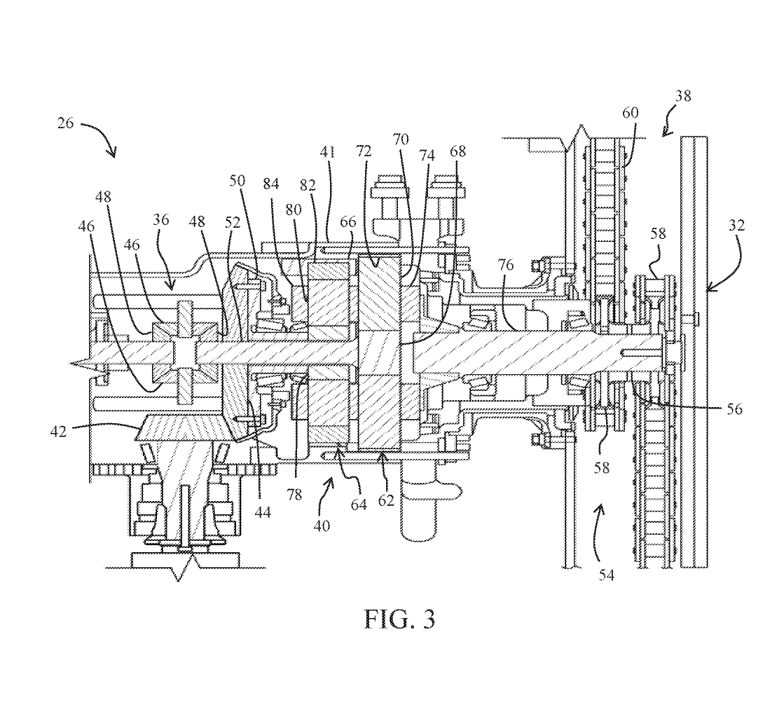

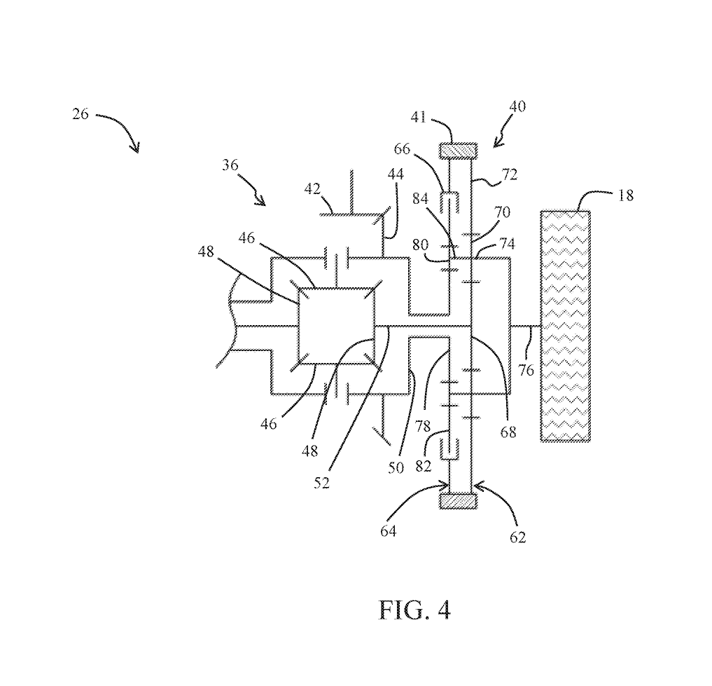

Referring to FIGS. 3 and 4, there is shown an RHS portion of the drive assembly 26 of the motor grader 10. The drive assembly 26 includes a differential gear arrangement 36, two tandems 38 (one of which is shown in FIGS. 3 and 4), and two final drive arrangements 40 (one of which is shown in FIGS. 3 and 4). In the current embodiment, the drive assembly 26 employs the differential gear arrangement 36, in conjunction with, an individual final drive arrangement 40 and an individual tandem 38, to drive the rear wheels 18 on each of the first side 32 and the second side 34 of the motor grader 10. Although, structure and arrangement between the differential gear arrangement 36, the final drive arrangement 40, and the tandem 38, to drive the rear wheels 18 installed on the first side 32, will be described hereinafter. Similar structure and arrangement between the differential gear arrangement 36, another final drive arrangement (not shown), and another tandem (not shown), to drive the rear wheels 18 installed on the second side 34, may also be contemplated.

The differential gear arrangement 36 is installed within an axle housing 41. The differential gear arrangement 36 includes a pinion gear 42, a ring gear 44, two or more spider gears 46, two side gears 48, a differential housing 50, and two differential output shafts 52. The pinion gear 42 is connected to the engine (not shown) and is adapted to receive the engine torque. More specifically, the pinion gear 42 is rotated, upon actuation of the engine (not shown). The pinion gear 42, the ring gear 44, the spider gears 46, the side gears 48, and the differential housing 50 are arranged in a specific manner, such that a rotational motion of the pinion gear 42 corresponds to a rotational motion of each of the differential housing 50 and the side gears 48 of the differential gear arrangement 36.

Furthermore, each of the two differential o put shafts 52 are connected to and driven by each of the two side gears 48. Correspondingly, the two differential output shafts 52 rotate in conjunction with the differential housing 50 of the differential gear arrangement 36, such that the average speed of the two differential output shafts 52 is equal to that of the differential housing 50 of the differential gear arrangement 36. Notably, the two differential output shafts 52 of the differential gear arrangement 36 rotate at the same speed, in a locked position of the differential gear arrangement 36. Although, structure and arrangement of a singular differential output shaft 52 with the final drive arrangement 40 and the tandem 38, to power the rear wheels 18 installed on the first side 32 of the motor grader 10, will be described hereinafter. Similar structure and arrangement of the other differential output shaft 52 with the other final drive arrangement not shown) and the other tandem (not shown), to power the rear wheels 18 installed on the second side 34 of the motor grader 10, may also be contemplated.

The tandem 38 is positioned outboard of the differential gear arrangement 36. The tandem 38 includes a wheel drive mechanism 54 positioned within a tandem housing (not shown). The wheel drive mechanism 54 is a chain drive mechanism that connects to and drives the rear wheels 18 installed on the first side 32 of the motor grader 10. The wheel drive mechanism 54 includes a base member 56, two sprockets 58 mounted on the base member 56, and a chain 60. The wheel drive mechanism 54 is arranged in a manner, such that a rotational motion of any of the base member 56, the two sprockets 58, and the chain 60 corresponds to a rotation of the rear wheels 18, installed on the first side 32 of the motor grader 10. In the current embodiment, the base member 56 of the wheel drive mechanism 54 is driven by one or more of the differential housing 50 and the differential output shaft 52, via the final drive arrangement 40. The final drive arrangement 40, in turn, drives the rear wheels 18 installed on the first side 32 of the motor grader 10. Although, the present disclosure contemplates usage of the tandem 40 in the motor grader 10, to drive the two rear wheels 18. Applicability to various other machines that employs a singular rear wheel 18 on each of the first side 32 and the second side 34, may also be contemplated. As is shown in FIG. 3, for such applications, the singular rear wheel 18 is directly driven by the differential output shaft 52, via the final drive arrangement 40.

The final drive arrangement 40 is connected to and driven by the differential output shaft 52 of the differential gear arrangement 36. The final drive arrangement 40 includes a primary planetary gear assembly 62, a secondary planetary gear assembly 64, and a clutch 66. In normal operating conditions of the motor grader 10, the base member 56 of the wheel drive mechanism 54 is driven by the differential output shaft 52, via the primary planetary gear assembly 62. In side loaded operating conditions of the motor grader 10, the base member 56 of the wheel drive mechanism 54 is driven by a combination of the differential housing 50 and the differential output shaft 52, via the primary planetary gear assembly 62 and the secondary planetary gear assembly 64, respectively.

The primary planetary gear assembly 62 is a conventional epicyclic gear train positioned within the axle housing 41, outboard of the differential gear arrangement 36 and the secondary planetary gear assembly 64. The primary planetary gear assembly 62 includes a first sun gear 68, two first planetary gears 70, a first ring gear 72, and a first planetary carrier 74. The first sun gear 68 is connected to and powered by the differential output shaft 52. Additionally, the first ring gear 72 is fixedly attached to the axle housing 41 and is therefore kept stationary. Therefore, a rotational motion of the first sun gear 68 corresponds to a rotational motion of the first planetary carrier 74. Moreover, the first planetary carrier 74 is attached to the base member 56 of the wheel drive mechanism 54, via a co-axial drive shaft 76. Therefore, a rotational motion of the first planetary carrier 74 corresponds to a rotation of the base member 56 of the wheel drive mechanism 54 and correspondingly the rear wheels 18, installed on the first side 32 of the motor grader 10.

The secondary planetary gear assembly 64 is also conventional epicyclic gear train positioned within the axle housing 41, outboard of the differential gear arrangement 36 and inboard of the primary planetary gear assembly 62. The secondary planetary gear assembly 64 includes a second sun gear 78, a number of second planetary gears 80 (two of which are shown in FIGS. 3 and 4), a second ring gear 82, and a second planetary carrier 84. The second sun gear 78 is attached to and powered by the differential housing 50. Moreover, the second planetary carrier 84 is fixedly attached to the first planetary carrier 74, and correspondingly is fixedly attached to the base member 56 of the wheel drive mechanism 54. The second ring gear 82 is adapted to operate in a free state and a partially restricted state, with use of the clutch 66. In the free state, the second ring gear 82 rotates freely and minimal rotational torque is transferred is transferred from the differential housing 50 to the secondary planetary gear assembly 64. More specifically, the torque required to rotate the secondary planetary gear assembly 64, is transmitted to the secondary planetary gear assembly 64. In the partially restricted state, the clutch 66 applies a resistance to the rotational motion of the second ring gear 82, to facilitate a slipping motion of the second ring gear 82 relative to the clutch 66. The resistance to rotational motion of the second ring gear 82 facilitates the second planetary carrier 84 of the secondary planetary gear assembly 64 to receive substantial amount of torque from the differential housing 50. This rotational torque of the second planetary carrier 84 is transmitted to the first planetary carrier 74, which adds on to the total torque received by the first planetary carrier 74 and correspondingly the rear wheel 18 installed on the first side 32.

The clutch 66 is an electro-hydraulic brake arrangement mounted on the axle housing 41 and positioned along a periphery of the second ring gear 82. The clutch 66 is adapted to switch the second ring gear 82 between the free state and the partially restricted state. More specifically, the clutch 66 is adapted to at least partially engage and disengage with the second ring gear 82, to correspondingly at least partially restrict and allow the rotational motion of the second ring gear 82. Although, the clutch 66 is described as the electro-hydraulic brake arrangement, various other types of the clutch 66 may also be contemplated. Examples of the clutch 66 may include, such as hut not limited to, a pneumatic clutch, a hydraulic clutch, and an electric clutch.

### INDUSTRIAL APPLICABILITY

In operation, the motor grader 10 is maneuvered on the ground surface, to level the ground surface during grading operation. In certain operating conditions of the motor grader 10, the blade 20 is positioned perpendicular to the direction of travel of the motor grader 10. In such situations, the rear wheels 18 installed on each of the first side 32 and the second side 34 are required to receive equal amount of torque. Therefore, in the normal mode of operation of the motor grader 10, the clutch 66 of the final drive arrangement 40 is kept disengaged from the second ring gear 82, on each of the first side 32 and the second side 34 of the motor grader 10. In this position, the base member 56 of the wheel drive mechanism 54, is driven by the differential output shaft 52, via the primary planetary gear assembly 62 of the final drive arrangement 40. The wheel drive mechanism 54, in turn, rotates the rear wheels 18, to maneuver the motor grader 10 forward.

Furthermore, in side-loaded operating conditions of the motor grader 10, the blade 20 is positioned at an angle relative to the motion of the motor grader 10. To counteract the side load in such situations, the rear wheels 18 are required to receive relatively higher torque on one of the first side 32 and the second side 34, relative to the other of the first side 32 and the second side 34. For example, the rear wheels 18 installed on the first side 32 may require to receive relatively higher torque. In order to facilitate this selective torque transmission, the clutch 66 of the final drive arrangement 40 on the first side 32, is initially triggered by a control system (not shown). As the clutch 66 of the final drive arrangement 40 is triggered, the clutch 66 partially engages with the second ring gear 82. This causes the second ring gear 82 to be adjusted to the partially restricted state. In the partially restricted state of the second ring gear 82, the second planetary carrier 84 of the secondary planetary gear assembly 64 receives substantial amount of torque from the differential housing 50. This torque is transmitted from the second planetary carrier 84 of the secondary planetary gear assembly 64 to the first planetary carrier 74 of the primary planetary gear assembly 62, which causes an increased amount of torque transmitted to the first planetary carrier 74. Correspondingly, the first planetary carrier 74 transmits an increased amount of torque to the rear wheels 18 installed on the first side 32 of the motor grader 10. Notably, negligible power is wasted, while facilitating the selective torque transmission to the rear wheels 18 in the disclosed drive assembly 26. This increases the overall efficiency of the drive assembly 26, to facilitate torque vectoring in the rear wheels 18 of the motor grader 10.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to those skilled in the art. It is not desired to limit the disclosure to the exact construction and operation illustrated and described, and, accordingly, all suitable modifications and equivalents may be resorted to that fall within the scope of the disclosure,.

What is claimed is:

1. A drive assembly for a machine, the drive assembly comprising:
a differential gear arrangement including a differential housing and at least one output shaft; and
at least one final drive arrangement configured to be selectively driven by the differential housing and the at least one differential output shaft, the at least one tandem drive including:
a primary planetary gear assembly including a first sun gear, at least one first planetary gear, a first ring gear, and a first planetary carrier, wherein one of the at least one first planetary gear and the first ring gear is stationary, the first sun gear is powered by the at least one differential output shaft of the differential gear arrangement, and the first planetary carrier is fixedly connected to a wheel drive mechanism;
a secondary planetary gear assembly including a second sun gear, at least one second planetary gear, a second ring gear, and a second planetary carrier,
wherein the second sun gear is connected to and powered by the differential housing of the differential gear arrangement,
wherein the second planetary carrier is fixedly connected to the first planetary carrier; and
a clutch adapted to engage and disengage the second ring gear, to correspondingly restrict and release the second ring gear of the secondary planetary gear assembly.
